(19) United States
(12) Patent Application Publication
(10) Pub. No.: US 2004/0056529 A1
(43) Pub. Date: Mar. 25, 2004

(54) Hydraulic unit for anti-slip brake systems

(76) Inventor: Albrecht Otto, Schoneck (DE)

Correspondence Address: RATNERPRESTIA, P O BOX 980, VALLEY FORGE, PA, 19482-0980, US

(21) Appl. No.: 10/250,589

(22) PCT Filed: Dec. 17, 2001
(86) PCT No.: PCT/EP01/14874

(30) Foreign Application Priority Data
Jan. 3, 2001 (DE) 10100103.7

(51) Int. Cl. B60T 8/36

(52) U.S. Cl. 303/119.3

(57) ABSTRACT

The present invention relates to a hydraulic unit for slip-controlled brake systems, the accumulator accommodating bore (1) thereof opening into the accommodating member (4) between the valve accommodating bores (2, 2′) of the two valve rows (X, Y).

The present invention relates to a hydraulic unit for slip-controlled brake systems according to the preamble of patent claim 1.

A hydraulic unit for a slip-controlled brake system is e.g. disclosed in German patent application DE 40 13 160 A1, where several valve accommodating bores accommodating inlet and outlet valves are arranged in a first and second valve row in the unit's accommodating member. Outside the two valve rows a pump bore is arranged in the block-shaped accommodating member. Further, a motor is disposed on the accommodating member outside the two valve rows, being aligned vertically to the pump bore. Further accommodating bores for accumulator elements and damping chambers are arranged vertically to the axes of the valve accommodating bores being spaced from the valve rows by means of the pump bore. In each of the two valve rows there are inlet and outlet valves, with the outlet valves being respectively positioned between the valve accommodating bores of the inlet valves so that also the accumulator elements that cooperate with the outlet valves in terms of function are arranged in alignment with one pair of outlet valves respectively.

The chosen arrangement automatically necessitates an appropriate space for the integration of all function elements in the accommodating member so that a relatively large block volume is produced which, in turn, necessitates a correspondingly large mounting space of the hydraulic unit inside a vehicle. It is considered another drawback that the pressure fluid ports leading to the wheel brakes are distributed on both side surfaces of the hydraulic unit and, thus, cause additional effort and cost in terms of assembly and construction for the connection of the brake lines.

In view of the above, an object of the present invention is to improve upon a hydraulic unit of the type referred to hereinabove in such a way that all accommodating bores and pressure fluid channels are optimally positioned within the accommodating member, while smallest possible housing dimensions are maintained, and a configuration for the hydraulic unit that is optimal under manufacturing aspects is achieved by corresponding drilling operations, assembly operations and in consideration of simple brake line connections at the accommodating member, allowing a simplest possible venting and, as the case may be, also exchangeability of individual components.

This object is achieved according to the invention for a hydraulic unit of the indicated type by way of the characterizing features of patent claim 1.

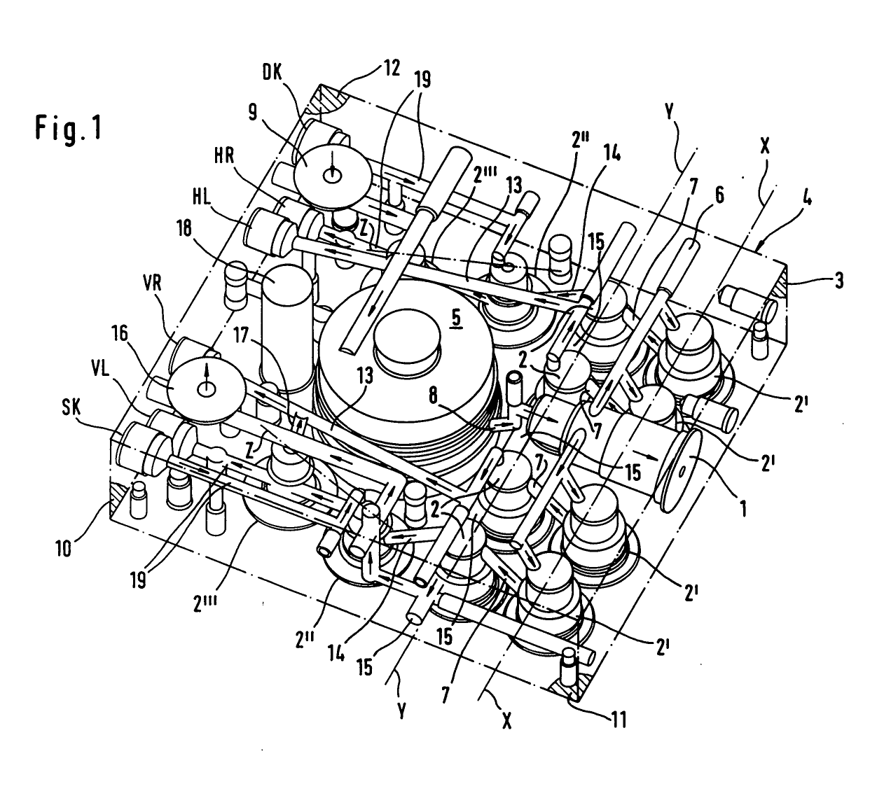

Further features and advantages of the invention can be taken in the following from the description of a hydraulic unit that is representative for the invention, by making reference to a drawing according to FIG. 1.

FIG. 1 depicts a three-dimensional view of an accommodating member 4 having all features essential for the invention to realize the desired hydraulic unit. Hence, the hydraulic unit is composed of a block-shaped accommodating member 4 accommodating inlet and outlet valves in several valve accommodating bores 2, 2′ of a first and second valve row X, Y, including a pump accommodating bore 5 that is arranged in the accommodating member 4 outside the two valve rows X, Y and contains a pump driven by an electric motor. Further, an accumulator accommodating bore 1 arranged between the two valve rows X, Y opens into the accommodating member 4. The valve, pump and accumulator accommodating bores 2, 2′, 5, 1 are connected to several pressure fluid channels which establish a hydraulic connection between the brake pressure generator connections DK, SK and the wheel brake connections VL, VR, HR, HL. The accumulator accommodating bore 1 is passed between the valve accommodating bores 2, 2′ of the two valve rows X, Y into a lateral surface of the accommodating member 4 and aligned transversely to the axis of rotation of the motor that extends coaxially to the axis of rotation of the pump so that the accumulator accommodating bore 1 is positioned closest possible to the pump accommodating bore 5. The accumulator accommodating bore 1 provided with a thread for receiving a high-pressure accumulator is consequently aligned diametrically to a second lateral housing surface 10, with all wheel brake connections VL, VR, HL, HR and brake pressure generator connections SK, DK being incorporated in said second lateral housing surface 10. The result is that all mounting operations for brake lines are concentrated on exclusively one housing surface of the accommodating member 4, while the first lateral housing surface 3 opposite the second lateral housing surface 10 is exclusively envisaged to accommodate the high-pressure accumulator. Transversely to the accumulator accommodating bore 1, a distributing channel 6 extends in parallel to the first valve row X in the accommodating member 4 and is tangent to the accumulator accommodating bore 1 in the form of a rupture (as shown) or, if required, also traverses it directly, said channel connecting the accumulator accommodating bore 1 to the valve accommodating bores 2′ of the first valve row that receives the electromagnetically operable inlet valves.

A suitable arrangement for the high-pressure accumulator is also achieved when the accumulator accommodating bore 1 extends from the second housing front face 12 at right angles to the arrangement shown in the drawing, i.e., in parallel beside the pump motor, so that the high-pressure accumulator may be positioned beside the pump motor.

Several valve accommodating bores 2″, 2′″ of a third valve row Z open beside the first and second valve row X, Y into a first housing end face 11 of the accommodating member 4 so that a so-called third valve row Z for each brake circuit is placed directly beside the pump accommodating bore 5.

The valve accommodating bores 2 of the second valve row Y that extend equally from the direction of the first housing end face 11 into the accommodating member 4 are designed as blind-end bores, with the valve accommodating bores 2 being grouped in pairs for each brake circuit in the valve row Y and connected by way of several connecting channels 7 to the valve accommodating bores 2′ of the first valve row X likewise grouped in pairs. Said connecting channels 7 are manufactured in a particularly simple fashion by drilling operations in the valve accommodating bores 2′ of the first valve row X directed at an angle of inclination towards the valve axes, said bores 2′ pointing at the bottom of the valve accommodating bores 2 of the second valve row Y by a corresponding selection of the angle of inclination.

The accumulator accommodating bore 1 disposed between the valve accommodating bores 2, 2′ arranged in pairs is connected to a pressure channel 8 that likewise opens into the pump accommodating bore 5 at an angle of inclination. It is possible in this arrangement as well to directly provide a connection, if required, to the accumulator accommodating bore 1 by way of a drilling operation directed transversely into the wall of the pump accommodating bore 5. Further, a pressure connection opens into the second housing end face that leads to the pressure channel 8 and to which a pressure sensor is connected. The accumulator accommodating bore 1 is expediently configured as a stepped bore in order to integrate there, if required, a non-return valve that closes in the direction of the pump accommodating bore 5 by way of the actual attachment of the high-pressure accumulator housing being screwed on.

The pump accommodating bore 5 as a blind-end bore is likewise pointing from the direction of the first housing end face 11 into the accommodating member 4. The pump accommodating bore 5 is connectable to the unpressurized supply reservoir of a brake pressure generator by way of a suction port 9 opening into the second housing end face 12.

On either side of the pump accommodating bore 5, brake pressure channels 13 start from the valve accommodating bores 2 of the second valve row Y and extend to the wheel brake connections VR, HL, said channels 13 being equally led as blind-end bores into the wheel brake connections HL, VR. The brake pressure channels 13 open into two diametrically facing blind-end bores which are connected to the valve accommodating bores 2 of the second valve row Y positioned directly adjacent to the accumulator accommodating bore 1. The valve accommodating bores 2 of the second valve row Y which are positioned remote from the accumulator accommodating bore 1 and arranged outside in the valve row Y are connected to the valve accommodating bores 2″, 2′″ of the third valve row Z by way of each one transverse channel 14 in order to establish a hydraulic connection to the brake pressure generator ports DK, SK in case of need, by way of a bypass channel 19 that intersects the valve accommodating bores 2″, 2′″ and opens into the wheel brake connections VL, HR.

Further, the valve accommodating bores 2 of the second valve row Y are penetrated by a collecting channel 15 that extends in parallel to the second valve row Y and passes outside the second valve row Y along with a channel coming from the direction of the first housing end face 3 to a supply reservoir connection 16 arranged on the second housing end face 12.

The valve accommodating bore 2″ of the third valve row Z accommodates a pressure compensating valve and the valve accommodating bore 2′″ of the third valve row Z accommodates a separating valve, the said separating valve in the electromagnetically energized switch position interrupting the channel 17 of the brake pressure generator connection SK respectively leading to the wheel brake connection VL, HR, while the pressure compensating valve inserted into the valve accommodating bore 2′″ in the non-energized position established a pressure fluid connection between the two wheel brake connections VL, VR by way of the bypass channel 19.

The compressed arrangement of the valve accommodating bore 2″, 2′″ of the valve row Z as well as the extremely compact arrangement of the pressure fluid channels arranged in this area is realized by the single, centric pump accommodating bore 5 into which a geared pump or vane-type pump, preferably in a cartridge-type construction, is inserted. Due to this construction a sufficiently large mounting space maintains—among others between the two brake pressure channels 13—for the integration of a cable conduit 18 in order to connect the electric motor that is arranged on the second housing end face 12 and provided for driving the pump to a controlling and/or regulating device arranged at the first housing end face 11 according to the principle of an electric plug. The compression of all valve accommodating bores permits not only shortening the pressure fluid conduits and decreasing the contents of pressure fluid but favors the venting ability of the hydraulic unit due to the proposed arrangement and channel routing.

Fluid flow through the accommodating member 4 for the pressure build-up in the brake system takes place in such a way that pressure fluid of a brake pressure generator reservoir propagates via the suction port 9 into the pump accommodating bore 5 and is conducted from there through the pump into the pressure fluid channel 8 that extends through a non-return valve into the accumulator accommodating bore 1 and, hence, into the high-pressure accumulator. Simultaneously, pressure fluid flows through the distributing channel 6 into the bottoms of the valve accommodating bores 2′ of the first valve row X. If the inlet valves inserted in the valve accommodating bores 2′ are switched electromagnetically into their open position for wheel pressure build-up, the pressure fluid is allowed to propagate by way of the connecting channels 7 into the bottoms of the valve accommodating bore 2 arranged in the second valve row Y, where it is supplied irrespective of the valve switch position of the outlet valves either directly for each of the two brake circuits via respectively one brake pressure channel 13 to the wheel brake connection VR or HL or indirectly via the transverse channel 14 into the bottom of the valve accommodating bore 2″ and from there to the wheel brake connection VL or HR.

When the outlet valves arranged in the second valve row Y and closed in the initial position are opened electromagnetically for brake pressure reduction, the pressure fluid disposed in the first valve row X will not propagate to the wheel brake connections VL, VR, HL, HR but will propagate directly to the unpressurized supply reservoir connection 16 via the collecting channel 15. The consequence is that also the pressure prevailing at the wheel brake connections VL, VR, HL, HR can relieve in reverse direction as shown in the drawing by way of the brake pressure channels 13 or the transverse channels 14 in the direction of the opened outlet valves and, hence, in the direction of the supply reservoir connection 16.

Disposed in the valve accommodating bore 2″ of each brake circuit is an electromagnetic separating valve which is switched to an open position only when the energy supply fails, i.e., upon failure of the pump or the high-pressure accumulator, in order to conduct pressure fluid, by way of the brake pressure generator connection SK or DK, bypassing the above-mentioned hydraulic circuit to the two wheel brake connections VL, VR or to the two wheel brake connections HL, HR directly by way of the bypass channel 19. A precondition of the latter channel connection is, however, that the pressure compensating valve inserted into the valve accommodating bore 2′″ is switched to its open position and the channel 17 is opened.

List of Reference Numerals:

| | |
|---|---|
| 1 | accumulator accommodating bore |
| 2, 2′ | valve accommodating bore |
| 2″, 2′″ | valve accommodating bore |
| 3 | first lateral housing surface |
| 4 | accommodating member |
| 5 | pump accommodating bore |
| 6 | distributing channel |
| 7 | connecting channel |
| 8 | pressure channel |
| 9 | suction port |
| 10 | second lateral housing surface |
| 11 | first housing end face |
| 12 | second housing end face |
| 13 | brake pressure channel |
| 14 | transverse channel |
| 15 | collecting channel |
| 16 | supply reservoir connection |
| 17 | channel |
| 18 | cable conduit |
| 19 | bypass channel |
| X, Y, Z | valve rows |
| VL | wheel brake connection, front left |
| VR | wheel brake connection, front right |
| HL | wheel brake connection, rear left |
| HR | wheel brake connection, rear right |
| DK | brake pressure generator connection |
| | (pressure piston circuit) |
| SK | brake pressure generator connection |
| | (secondary circuit) |

1. Hydraulic unit for slip-controlled brake systems,
including an accommodating member accommodating inlet and outlet valves in several valve accommodating bores of a first and second valve row,
including a pump bore that is arranged in the accommodating member outside the two valve rows,
including a motor arranged coaxially to the pump bore outside the two valve rows and directed into the accommodating member,
including an accumulator accommodating bore that opens into the accommodating member,
including several pressure fluid channels connecting the valve, pump and accumulator accommodating bores and being adapted to establish a hydraulic connection between several brake pressure generator connections and several wheel brake connections,
characterized in that the accumulator accommodating bore (1) opens into the accommodating member (4) between the valve accommodating bores (2, 2′) of the two valve rows (X, Y).

2. Hydraulic unit as claimed in claim 1,
characterized in that the accumulator accommodating bore (1) is aligned transversely to the axis of rotation of the motor so that the accumulator accommodating bore (1) opens into a first lateral housing surface (3) of the accommodating member (4) between the valve accommodating bores (2, 2′) of the first and second valve row (X, Y).

3. Hydraulic unit claimed in claim 1 or 2,
characterized in that the first lateral housing surface (3) is aligned diametrically to a second lateral housing surface (10) in which the wheel brake connections and brake pressure generator connections (VL, VR, HL, HR, DK, SK) are incorporated.

4. Hydraulic unit as claimed in claim 1,
characterized in that transversely to the accumulator accommodating bore (1), a distributing channel (6) extends in parallel to the first valve row (X) in the accommodating member (4) which is tangent to or traverses the accumulator accommodating bore (1) and connects the accumulator accommodating bore (1) to the valve accommodating bores (2′) of the first valve row (X).

5. Hydraulic unit as claimed in claim 1,
characterized in that several valve accommodating bores (2″, 2′″) of a third valve row (Z) open beside the first and second valve row (X, Y) into a first housing end face (11) of the accommodating member (4) so that the third valve row (Z) is placed directly adjacent to the pump accommodating bore (5).

6. Hydraulic unit as claimed in claim 3,
characterized in that the valve accommodating bores (2) of the second valve row (Y) as blind-end bores extend in sections into the accommodating member (4), and in that the valve accommodating bores (2) are arranged in pairs in the second valve row (Y), wherein several connecting channels (7) are directed at an angle of inclination from the bottom of the valve accommodating bore (2) to the section of the first housing end face (11) into which the valve accommodating bores (2′) of the first valve row (X) open in pairs.

7. Hydraulic unit as claimed in claim 1,
characterized in that the accumulator accommodating bore (1) is connected to a pressure channel (8) between the valve accommodating bores (2, 2′) arranged in pairs of the first and second valve row (X, Y), said channel opening into the pump accommodating bore (5) at an angle of inclination.

8. Hydraulic unit as claimed in claim 6,
characterized in that the pump accommodating bore (5) as a blind-end bore extends from the direction of the first housing end face (11) and opens into the accommodating member (4), and in that a suction port (9) is provided on the second housing end face (12) opposed to the first housing end face (11), said suction port opening into the pump accommodating bore (5).

9. Hydraulic unit as claimed in any one of the preceding claims,
characterized in that on either side of the pump accommodating bore (5), brake pressure channels (13) extend from the valve accommodating bores (2) of the second valve row (Y) to the wheel brake connections (VR, HL), said channels (13) being provided as blind-end bores in the wheel brake connections (VR, VL or HR, HL).

10. Hydraulic unit as claimed in claim 9,
characterized in that the valve accommodating bores (2) of the second valve row (Y) positioned directly adjacent to the accumulator accommodating bore (1) are connected to the brake pressure channel (13) by way of a blind-end bore, and in that the valve accommodating bores (2) of the second valve row (Y) which are positioned remote from the accumulator accommodating bore (1) are connected to the valve accommodating bores (2″, 2′″) of the third valve row (Z) by way of transverse channels (14) that establish a pressure fluid connection to the brake pressure generator connections (VL, HR).

11. Hydraulic unit as claimed in any one of the preceding claims,
characterized in that the valve accommodating bores (2) of the second valve row (Y) are penetrated by a collecting channel (15) that extends in parallel to the second valve row (Y) and leads to a supply reservoir connection (16) arranged on the second housing end face (12).

12. Hydraulic unit as claimed in claim 5,
characterized in that the valve accommodating bores (2″, 2′″) of the third valve row (Z) accommodate a pressure compensating valve and a separating valve, the said separating valve in the electromagnetically energized switch position interrupting the bypass channel (19) between the brake pressure generator connection (SK) and the wheel brake connection (VL), and in that the pressure compensating valve when energized electromagnetically interrupts a channel (17) that leads from the valve accommodating bore (2″) to the brake pressure channel (13) so that the two wheel brake connections (VL, VR) for the diagonal wheel brakes are hydraulically separated from each other.

13. Hydraulic unit as claimed in any one of the preceding claims,
characterized in that a pump cartridge which accommodates a geared pump or vane-type pump is inserted into the pump accommodating bore (5).
